(19) United States
(12) Patent Application Publication
(10) Pub. No.: US 2014/0342034 A1
(43) Pub. Date: Nov. 20, 2014

(54) Pet Food Container

(71) Applicant: Petstages, Inc., Northbrook, IL (US)

(72) Inventors: Kristian Buschmann, Chicago, IL (US); Jennifer Crotty, Lake Bluff, IL (US); Steve Bisbikis, Hawthorn Woods, IL (US)

(73) Assignee: Petstages, Inc., Northbrook, IL (US)

(21) Appl. No.: 14/276,030

(22) Filed: May 13, 2014

Related U.S. Application Data
(60) Provisional application No. 61/823,012, filed on May 14, 2013.

(51) Int. Cl. A01K 5/01

(52) U.S. Cl. CPC A01K 5/01
USPC 426/2

(57) ABSTRACT

A pet food container provides a bottom surface and a sidewall extending upwardly from and around the exterior of the bottom surface for forming or defining a feeding area within the pet food container. Pet food is inserted inside the feeding area and then equally spread across the entire surface area of the bottom surface of the feeding area forming a single or shallow layer of pet food within the pet food container. The pet food is then consumed by the pet food within the pet food container. The pet food is then consumed by the pet in many small bites of pet food from the single or shallow layer in the feeding area until the pet food is gone or the pet is finished eating. The pet food container further provides walls and curved surfaces to force the pet food back into the feeding area if displayed by the pet during feeding. Also, feet are provided to the bottom of the pet food container to prevent the pet food container from being pushed along the floor or moved by the pet during feeding.

### I. CROSS-REFERENCE TO RELATED APPLICATION

This patent application is a non-provisional application claiming priority from U.S. Provisional Patent Application Ser. No. 61/823,012, entitled “Pet Food Container,” filed on May 14, 2013, and is fully incorporated herein by reference.

### II. FIELD OF THE INVENTION

The present invention relates to pet food containers and, more particularly, to an improved pet food container for reducing the amount of food that a pet can consume in each bit while feeding.

### III. DESCRIPTION OF THE PRIOR ART

During feeding, pets often eat too quickly. While there are many reasons that pets may eat too quickly (which are not discussed herein), this common occurrence can cause several health conditions and/or unpleasant side effects for the pet.

For example, one of the more serious is the dangerous or possibly life-threatening condition called “bloat, ” also more technically referred to as Gastric Dilatation-Volvulus (GDV). When the pet eats too quickly, the pet often swallows too much air while ingesting the food. If enough excess air is ingested too quickly, this could make the stomach of the pet swell and/or possibly twist which could cause surrounding blood vessels to likewise twist and constrict. If this occurs, the pet may experience or show many signs which include but are not limited to unsuccessfully trying to vomit, panting or shallow breathing, unfamiliar or the absence of any digestive sounds after eating, or the pet may otherwise appear in some form of distress. In the most serious situations, the pet may require surgery or, worse yet, if untreated, this condition could possibly take the pet's life.

Although less dangerous of life-threatening than bloat, the pet may also experience gas (e.g., in the form of belching or passing pas), regurgitation due to a lack of retching (e.g., in the form of mostly unchewed food), and possibly other unpleasant side effects.

As a result, emerging animal science is guiding pet owners to slow the eating pace of their pets to lessen the amount of air swallowed while eating, reduce overeating, improve digestion, etc. Pet bowls currently in the marketplace are typically deep bowls designed to hold several to many cups of food and allow dogs to gulp large amounts of food in one bite. Recently the industry has responded by (1) creating similarly deep bowls with protrusions from the bowl that limit the dogs ability to get to the food, this slowing pace of eating or (2) by adding a large object into the bowl that also lessens the pets access by covered the food, therefore slowing eating. Unfortunately, with either of these approaches to slowing eating, the pet often becomes frustrated with the barriers to the food and may paw or tip the bowl creating a mess and frustration for both the pet and owner.

Applicant, however, concerned with and dedicated to the welfare of pets, has solved this problem with its unique improved pet food container. Applicant's shallow/single layer feeding pet food container offers an entirely novel way of slowing down a pet's pace while eating. By changing the shape of the feeding pet food container or dish from the traditional deep bowl to a wider, shallow flat shape, food is arranged in the pet food container or dish in a single or shallow layer rather than a deep trough like other pet bowls. This single or shallow layer configuration of the food/kibble prohibits the pet from getting larger mouthfuls of food in a single gulp, unlike deeper dishes. This configuration requires much more time to eat than traditional bowls. In addition, because the pet food container or dish does not have barrier between the pet and food, the pet has complete access to the food and is not frustrated in the eating process, lessening the mess and frustration of the pet and owner.

Accordingly, there is a need and there has never been disclosed Applicant's unique pet food container and system and method for using the pet food container.

### IV. SUMMARY OF THE INVENTION

The present invention is an inventive pet food container and method for feeding a pet. The pet food container provides a bottom surface and a sidewall extending upwardly from and around the exterior of the bottom surface for forming or defining a feeding area within the pet food container. Pet food is inserted inside the feeding area and then equally spread across the entire surface area of the bottom surface of the feeding area forming a single or shallow layer of pet food within the pet food container. The pet food is then consumed by the pet in many small bites of pet food from the single or shallow layer in the feeding area until the pet food is gone or the pet is finished eating. The pet food container further provides walls and curved surfaces to force the pet food back into the feeding area if displayed by the pet during feeding. Also, feet are provided to the bottom of the pet food container to prevent the pet food container from being pushed along the floor or moved by the pet during feeding.

### V. BRIEF DESCRIPTION OF THE DRAWINGS

The Description of the Preferred Embodiment will be better understood with reference to the following figures:

FIG. 1 is top perspective view of the pet food container.

FIG. 2 is a bottom perspective view of the pet food container.

FIG. 3 is a cross sectional view, taken along line 3-3 of FIG. 2, of the side of the pet food container.

FIG. 4 is top perspective view of an alternate embodiment of the pet food container.

FIG. 5 is a bottom perspective view of the alternate embodiment of the pet food container.

FIG. 6 is a cross sectional view, taken along line 6-6 of FIG. 5, of the side of the alternate embodiment of the pet food container.

FIG. 7 is a top perspective view of the pet food container and, in particular, illustrating filling the pet food container for feeding the pet using the inventive process.

FIG. 8 is a cross sectional view, taken along line 8-8 of FIG. 7, and in particular illustrating the single of shallow layer of pet food spread across the bottom surface of the feeding area.

FIG. 9 is a top perspective view of the pet food container and, in particular, illustrating the pet feeding from the pet food container using the inventive process.

### DETAILED DESCRIPTION OF THE PREFERRED EMBODIMENT

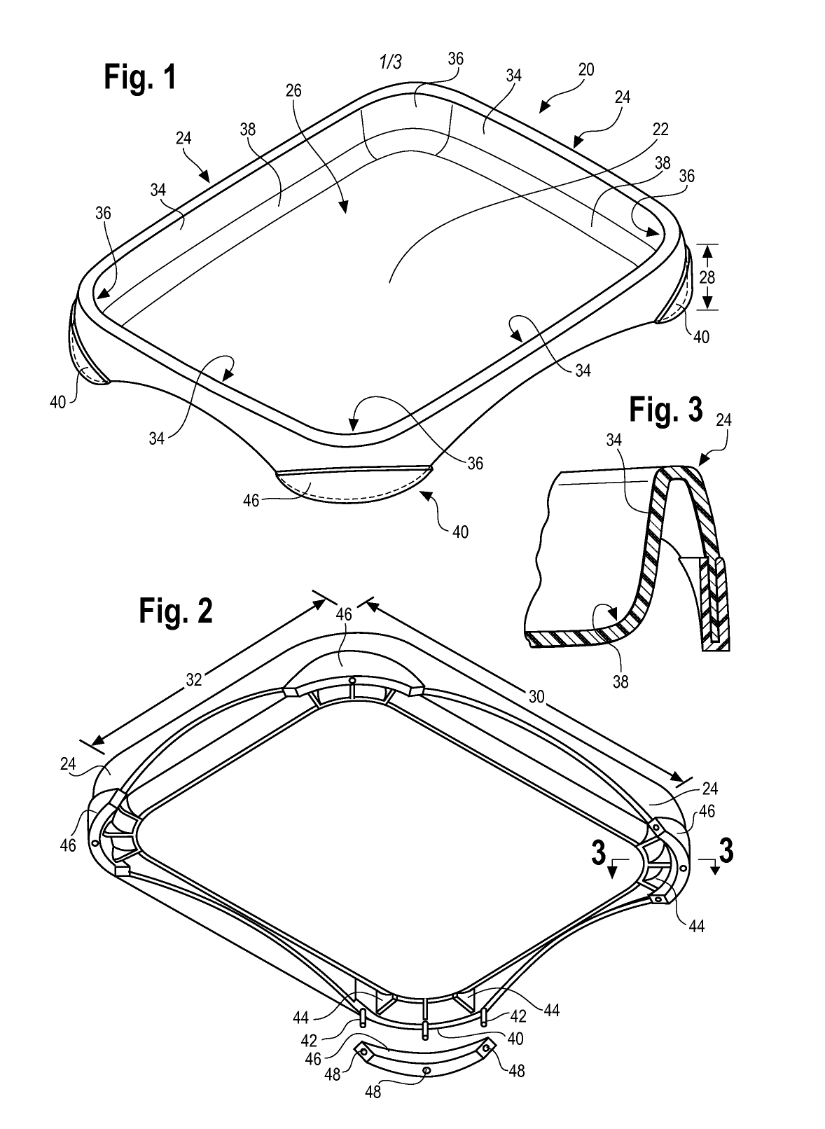

Turning first to FIG. 1, there is illustrated Applicant's unique pet food container 20. The pet food container 20 comprises a bottom surface 22 and a sidewall 24 extending upwardly from and around the exterior of the bottom surface 22. The bottom surface 22 and the upwardly extending sidewall 24 form or define a feeding area 26.

The upwardly extending sidewall 24 comprises walls 34 integrally molded by corners 36 to form the upwardly extending sidewall 24. Preferably, each of the corners 36 are rounded or provided with a smooth curved surface. Likewise, the walls 34 are integrally molded with the bottom surface 22 by rounded or smooth curved surfaces 38. In this manner, and as described herein, the corners 36 and the curved surfaces 38 prevents any pet food from becoming lodged or unavailable to the pet during feeding and facilitates easy cleaning of the pet food container 20.

The pet food container 20 is preferably rectangular in shape. Alternatively, it is contemplated that the shape of the pet food container 20 may be any other shape provided that the pet food container 20 is designed to accommodate Applicant's intended invention as disclosed herein.

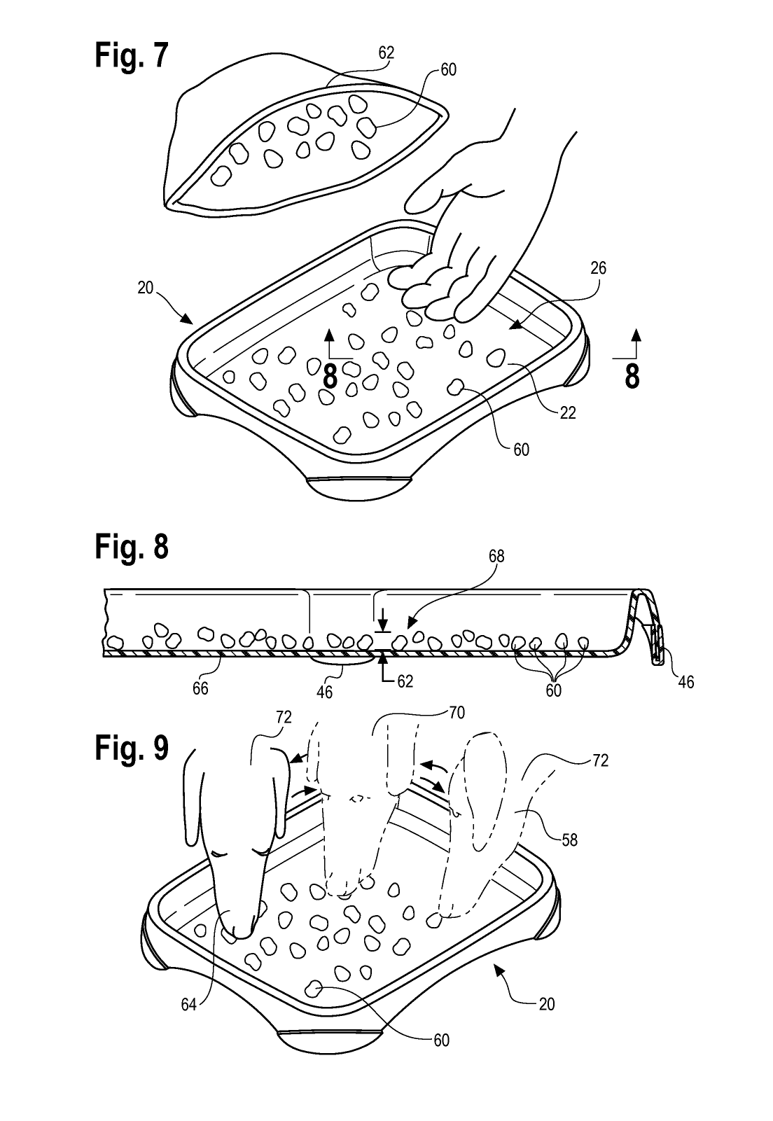

In the preferred embodiment, the upwardly extending sidewall 24 has a height 28 sufficient to receive the pet food 60 (see FIG. 7) within the feeding area 26 and prevent the pet food 58 from easily being pushed out of the pet food container 20 by the pet 58 (see FIG. 9). Alternatively, the height 28 of the pet food container 20 may be higher or lower as is known to one skilled in the art provided that the height 28 of the pet food container 20 is designed to accommodate Applicant's intended invention as disclosed herein.

In the preferred embodiment, the feeding area 26 has a length 30 and width 32, as illustrated in FIG. 2, sufficient to receive the desired amount of pet food within the feeding area 26 and feed the pet in the manner as disclosed herein. Alternatively, the length 30 and width 32 of the pet food container 20 may be higher or lower as is known to one skilled in the art provided that the length 30 and width 32 of the pet food container 20 are designed to accommodate Applicant's intended invention as disclosed herein.

In the preferred embodiment, the pet food container 20 is made of a durable plastic material. Alternatively, the pet food container 20 may made entirely of a stainless steel material, or the sidewall 24 may be made in a polished stainless steel while the feeding area 26 may be made in a non-polished stainless steel, or the pet food container 20 may be made of any other material or, combination of materials, as is known to one skilled in the art. Additionally, a removeable liner may be included to cover any portion of the feeding area 26 (e.g., such as bottom surface 22 only), all of the feeding area 26 (e.g., such as bottom surface 22 and upwardly extending sidewall 24), or even the entire pet food container 20, if desired.

Feet 40 are used to support the pet food container 20. Each of the plurality of feet 40 are provided with a plurality of dowel pins 42. Each of the plurality of feet 40 are covered by a sheath 46. In the preferred embodiment, the sheath 46 comprises an opening 50 for covering each of the plurality of feet 40. As the sheath 46 is inserted over the plurality of feet 40, the plurality of dowel pins 42 are received into a plurality of recesses 48 situated within the sheath 46. In this manner, the sheath 46 is secured to the each of the plurality of feet 40. A plurality of splines 44 are illustrated for additional structural strength.

Preferably, the sheath 46 is made of a rubber material or other non-skid material known to one skilled in the art. In this manner, during use, the sheath 46 will restrict the pet food container 20 from being easily pushed along the floor or moved by the pet 58 during feeding.

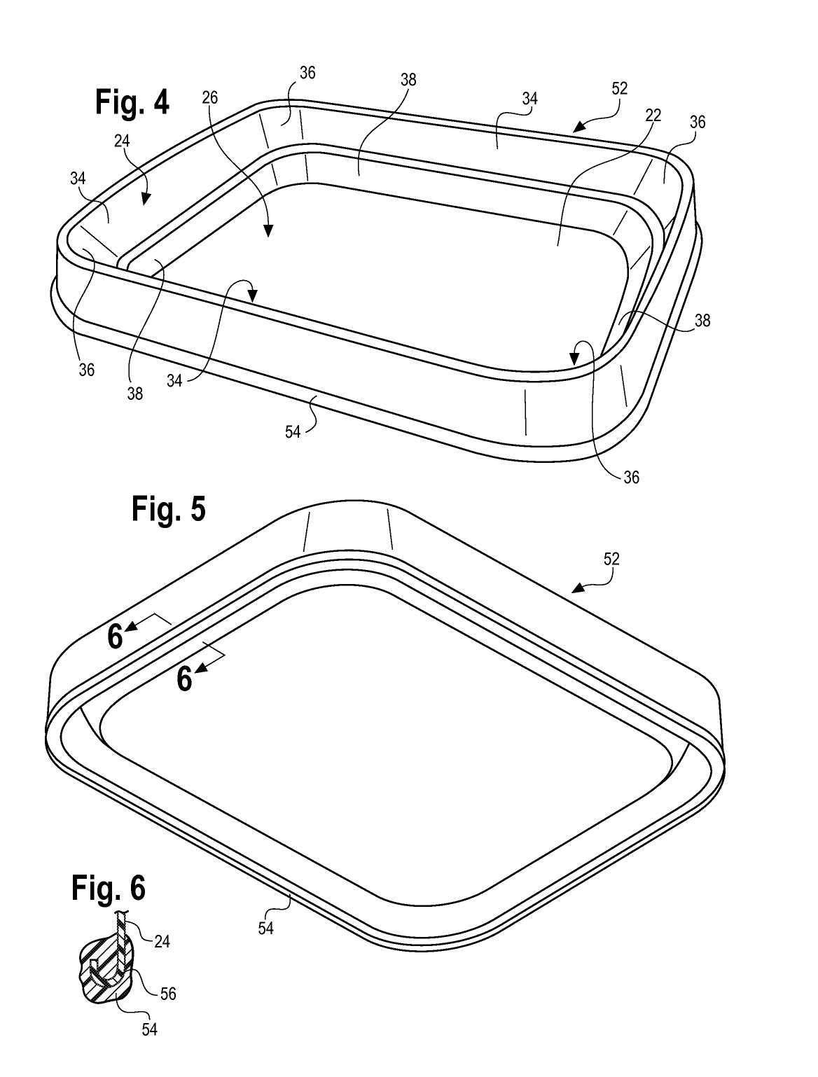

Turing to FIG. 4 illustrates an alternate embodiment of the pet food container 52. The pet food container 52 provides the exact same components as the pet food container 20 including but not limited to the bottom surface 22, sidewall 24, feeding area 26, walls 34, corners 36, and curved surface 38.

In this alternate embodiment of the pet food container 52, the sidewall 24 terminates in a base 56. Preferably, the base 56 is in the shape of a J-hook, as illustrates in FIG. 6. Situated around the base 56 of the pet food container 52 is a gasket 54. Preferably, the gasket 54 is made of a rubber material or other non-skid material known to one skilled in the art. In this manner, during use, the gasket 54 will prevent the pet food container 52 from being easily pushed along the floor or moved by the pet 58.

Applicant states that the shapes and dimensions of the pet food container 20 may be of varying dimensions, or any other sized, shapes, and/or dimensions as known to one skilled in the art provided that the pet food container 20 is designed to accommodate Applicant's intended invention as disclosed herein.

In use and when feeding, pet food 60 is retrieved from a pet food receptacle 62 with the retrieved pet food 60 being inserted inside the feeding area 26 of the pet food container 20, as illustrated in FIG. 7. The pet food 60 may be any type or kind of pet food that is known to one skilled in the art provided the pet food is used in the manner as disclosed herein. In the preferred embodiment, the amount of per food 60 should preferably be substantially the same or similar amount that one would normally feed the pet 58 for a single feeding. Alternatively, the amount of pet food 60 may be any amount as desired by the user provided the pet food container 20 is used in the manner described herein. This amount of pet food 60 is then equally spread across the entire surface area of the bottom surface 22 of the feeding area 26 for forming an eating surface 66. In this manner, the amount of pet food 60 for the feeding the pet 58 is not all contained in a large section, in a vertical stack, and/or in an isolated mound. Rather, the pet food 60 is reduced or disbursed into a single or shallow layer 62 across the entire surface area of the bottom surface 22 of the feeding area 26 and into a plurality of small bites of pet food 68, as illustrated in FIG. 8.

As a result, upon allowing the pet to begin feeding, the pet 58 is prevented from being able to consume or eat all of the pet food 60 from a large section, a vertical stack, and/or from an isolated mound. Instead, as illustrated in FIG. 9, the pet 58 is forced to consume or eat small bites of pet food 60 from the plurality of small bites of pet food 68 from the single or shallow layer 62 spread across the entire surface area of the bottom surface 22 of the feeding area 26. In this manner, the pet 58 is only able to injest a limited amount of pet food 60 per each small bite until the pet food 60 is gone or the pet 58 is finished feeding. Additionally, as the pet 58 is feeding or interacting with the pet food 60, the snout 64, for example, tongue, teeth, or paws may push or further displace some of the pet food 60 across across the entire surface area of the bottom surface 22 of the feeding area 26 likewise assisting in maintaining the pet food 60 in a plurality of small bites of pet food 68.

Additionally, upon the pet 58 approaching the pet food container 20 to begin feeding, the pet 58 defines an initial position 70 relative to the pet food container 20. In this initial position 70, the pet 58 begins consuming small bites of pet food 60 from the plurality of small bites of pet food 68 from the feeding area 26 that is within reach of the pet 58 from this initial position 70. Upon the pet food 60 within reach of the pet 58 from this initial position 70 being consumed, the pet 58 is then forced to change from the initial position 70, either moving around the pet food container 20 in the counter-clockwise direction A or clockwise direction B to a second position 72. In this manner, the pet 58 is forced to take additional time to move from the initial position 70 to the second position 72 and to locate the additional pet food 60 within the feeding area 26 and in order to continue to eat. Upon reaching this second position 72, the pet 58 can then continue consuming small bites of pet food 60 from the plurality of small bites of pet food 68 from the feeding area 26 that is within reach of the pet 58 from this second position 72. The pet 58 continues in this manner until the pet 58 is forced to move to a third position (not illustrated) for the same reason, or until the pet food 68 is gone, or the pet is finished feeding. In the preferred embodiment, the forcing of the pet 58 to move from the initial position 70 to the second position 72 and possibly further positions is accomplished by providing the single or shallow layer 62 of the plurality of small bites of pet food 68 within the feeding area 26 to have a length 30, width 32, and/or combination of both to be substantially large enough to prevent the pet 58 from consuming all of the pet food 60 from the initial position 70.

Should any of the pet food 60 be pushed up against the walls 34 or corners 36, the walls 34 and corners 36 will retain the pet food 60 within the pet food container 20 and allow the pet food 60 to slide down the curved surface 38 and into the feeding area 26 of the pet food container 20.

As a result, while the pet 58 still receives the same amount of pet food 60 during feeding for its nutritional and healthy value, the inventive process of using the pet food container 20 slows the eating process for the pet 58 and thereby prevents the pet 58 from eating too quickly. Based on the foregoing pet food container and the inventive method for using Applicant's pet food container, Applicant's unique product provides the following advantages which include but are not limited to:

1. safely forces the pet to slow their eating pace and thereby take longer for the pet to normally eat;

2. assists in reducing the occurrence of the pet overeating and/or eating too quickly;

3. improves the pet's digestion during and after feeding;

4. assists in reducing the dangerous or possibly life-threatening condition called “bloat,” also more technically referred to as Gastric Dilation-Volvulus (GDV);

5. assists in reducing the occurrence of the pet swallowing too much air while ingesting the pet food;

6. assists in reducing the occurrence of the swelling and/or possibly twisting of the stomach of the pet which could cause surrounding blood vessels to likewise twist and constrict from which the pet may experience or show many signs such as unsuccessfully trying to vomit, panting or shallow breathing, unfamiliar or the absence of any digestive sounds after eating, or other form of distress;

b 7. assists in reducing gas (e.g., in the form of belching or passing gas), regurgitation due to a lack of retching (e.g., in the form of mostly unchewed food), and possibly other unpleasant side effects;

8. reduces or eliminates tipping of pet food bowls; and

9. provides a pet food container of dish that does not have barriers between the pet and food, where the pet has complete access to the food, is not frustrated in the eating process, and also lessens the mess and frustration of the pet and owner.

Thus, there has been provided Applicant's unique pet food container and method for using the same. While the invention has been described in conjunction with a specific embodiment, it is evident that many alternatives, modifications and variations will be apparent to those skilled in the art in light of the foregoing description. Accordingly, it is intended to embrace all such alternatives modifications and variations as fall within the spirit and scope of the appended claims.

What is claimed is:

1. A method for feeding a pet, comprising the step of:
inserting pet food into a feeding area within a pet food container;
spreading the pet food across the surface area of the feeding area, the pet food being reduced into a shallow layer across the surface area of the feeding area and providing the pet food into a plurality of small bites of pet food;
allowing a pet to begin feeding from the pet food container; and
the plurality of small bites of pet food from the shallow layer in the feeding area being consumed by the pet until the pet food is gone or the pet is finished feeding, each of the small bites of pet food from the plurality of small bites of pet food being consumed through a plurality of bites by the pet.

2. The method of claim 1 and further comprising the step of obtaining the pet food from a pet food receptacle.

3. The method of claim 1 and further comprising the step of equally spreading the pet food across the surface area of the feeding area.

4. The method of claim 3 and further comprising the step of equally spreading the pet food across the entire surface area of the feeding area.

5. The method of claim 1 and further comprising the step of retaining the plurality of small bites of pet food back in the feeding area when displaced by the pet while the pet is consuming other small bites of pet food from the plurality of small bites of pet food.

6. The method of claim 1 and further comprising the step of defining an initial position of the pet relative to the pet food container when the pet begins feeding, the pet consuming small bites of pet food from the plurality of small bites of pet food in the feeding area that is within reach of the pet from the initial position.

7. The method of claim 6 and further comprising the step of forcing the pet to change from the initial position to a second position relative to the pet food container for the pet to continue to consume small cites of pet food from the plurality of small bites of pet food in the feeding area within reach of the pet from the second position.

8. The method of claim 1 and further comprising the step of restricting the pet food container from being pushed along the floor or moved by the pet during feeding.

9. A method for feeding a pet, comprising the step of:
inserting pet food into a feeding area within a pet food container, the feeding area substantially providing an eating surface;
spreading the pet food across the eating surface of the feeding area, the pet food being disbursed into a layer across the eating surface of the feeding area;
allowing a pet to begin feeding from the eating surface in the feeding area, the pet defining an initial position relative to the pet food container when the pet begins feeding, the pet consuming the pet food from the eating surface in the feeding area that is within reach of the pet from the initial position;
forcing the pet to change from the initial position to a second position relative to the pet food container for the pet to continue to consume pet food from the eating surface in the feeding area; and
the pet food from the feeding area being consumed by the pet until the pet food is gone or the pet is finished feeding.

10. The method of claim 9 and further comprising the step of inserting into the feeding area substantially the amount of pet food for a single feeding.

11. The method of claim 9 and further comprising the step of providing the layer in the feeding area substantially large enough to prevent the pet from consuming all of the pet food from the initial position.

12. The method of claim 9 and further comprising the step of the pet food being consumed through a plurality of bites by the pet.
